(19) United States
(12) Patent Application Publication
(10) Pub. No.: US 2006/0207253 A1
(43) Pub. Date: Sep. 21, 2006

(54) Method for operating a supercharged internal combustion engine

(76) Inventors: Siegfried Sumser, Stuttgart (DE); Helmut Finger, Leinfelden-Echterdingen (DE); Peter Fledersbacher, Stuttgart (DE); Thomas Kuhn, Stuttgart (DE); Gernot Hertweck, Fellbach (DE)

Correspondence Address: WILLIAM COLLARD;COLLARD & ROE, P.C., 1077 NORTHERN BOULEVARD, ROSLYN, NY, 11576, US

(21) Appl. No.: 11/259,660

(22) Filed: Oct. 26, 2005

(30) Foreign Application Priority Data
Oct. 26, 2004 (DE) 102004051889.0

(51) Int. Cl. F02D 23/00

(52) U.S. Cl. 60/602

(57) ABSTRACT

In a method for operating a supercharged internal combustion engine, the exhaust gas turbine of which is equipped with a variable turbine geometry, if the pressure upstream of the compressor is higher than the pressure downstream of the compressor in the lower load/speed of the internal combustion engine, the variable turbine geometry is adjusted in the direction of its back-up position until the turbine efficiency is at least approximately in the region of the optimum efficiency.

### BACKGROUND OF THE INVENTION

The invention relates to a method for operating a supercharged internal combustion engine.

German Patent Application No. DE 102 21 014 A1 describes an internal combustion engine with exhaust gas turbocharger, the exhaust gas turbine of which is equipped with a variable turbine geometry for variably adjusting the turbine inlet cross section. The variable turbine geometry is adjusted in such a manner that the exhaust gas turbocharger rotational speed of the exhaust gas turbocharger is within a predetermined, permissible rotational speed range. This is achieved by virtue of the fact that, for example at low engine speeds and engine loads, the variable turbine geometry is adjusted in the direction of its back-up position, in which the free turbine inlet cross section adopts a minimum, after which the exhaust gas back pressure between internal combustion engine and exhaust gas turbine rises and the exhaust gas is passed through the remaining free cross section of flow at a high velocity and strikes the turbine wheel at this high velocity. It is in this way possible to keep the exhaust gas turbocharger rotational speed at a desired minimum level.

Furthermore, German Patent Application No. DE 102 21 014 A1 discloses running the compressor in turbine mode provided that, at low loads and speeds of the internal combustion engine, a sub-atmospheric pressure is present in the intake section immediately ahead of the cylinder inlets, with the result that a pressure drop is produced across the compressor, which can be used to drive the compressor impeller. This operating mode is also known as cold-air turbine operation of the compressor. Moreover, the compressor is assigned an additional drive which is used to compensate for an energy deficit of the exhaust gas turbine at certain operating points of the internal combustion engine. The rotational speed of the exhaust gas turbocharger can be kept approximately constant with the aid of the additional drive.

In turbine mode of the compressor, energy is fed to the charger by actuating the additional drive, in order to increase the exhaust gas turbocharger rotational speed, with the result that the compressor can be operated in the region of its optimum efficiency during its cold-air turbine mode. In this case, however, it should be taken into account that the exhaust gas turbine arranged in the exhaust section, on account of the increase in the exhaust gas turbocharger rotational speed, passes into an efficiency range at which the turbine begins to ventilate and consumes power, which has a braking effect on the exhaust gas turbocharger rotational speed.

### SUMMARY OF THE INVENTION

It is therefore an object of the invention to operate a supercharged internal combustion engine, the exhaust gas turbine of which is equipped with a variable turbine geometry, in such a manner as to produce efficiency-optimized operation of the exhaust gas turbocharger. In particular in the lower load/speed range of the internal combustion engine, in which the compressor is operated in cold-air turbine mode, both the compressor and the exhaust gas turbine should be operated in the region of their respective optimum efficiencies.

In the method according to the invention for operating a supercharged internal combustion engine, the exhaust gas turbine of the charger is equipped with a variable turbine geometry for variably adjusting the effective turbine inlet cross section between a minimum build-up position and a maximum open position. In the lower load/speed range of the internal combustion engine, in which the pressure upstream of the compressor is higher than the pressure downstream of the compressor and the compressor is operating in what is known as the cold-air turbine mode, the variable turbine geometry of the exhaust gas turbine is adjusted in the direction of its back-up position until the turbine efficiency of the exhaust gas turbine is at least approximately in the region of the optimum efficiency.

This defines a directly dependent relationship between the fast running speed of the exhaust gas turbocharger which is to be set and the narrowest turbine cross section, which is reached in the back-up position or at least close to the back-up position of the variable turbine geometry. It is in this way possible, in particular in cold-air turbine mode of the compressor, in which there is a pressure drop across the compressor, which is utilized to drive the compressor impeller, to operate both the compressor and the cold-air turbine in the region of their optimum efficiencies and also to operate the exhaust gas turbine in the region of its optimum efficiency. Increasing the turbine pressure ratio also increases the isentropic expansion rate and therefore also the turbine power of the exhaust gas turbine, which means that despite the higher rotational speed of the exhaust gas turbine, the optimum efficiency range is not departed from, and in particular an undesired ventilation mode, in which energy is consumed, is avoided.

In principle, these measures make it possible to dispense with an additional drive for the charger without the risk of efficiency losses or a drop in the charger rotational speed. Rather, the charger rotational speed is kept at an approximately constant and high level. Nevertheless, it may be expedient to provide an additional drive.

The compressor of the exhaust gas turbocharger expediently has an additional passage, which is formed separately from the compressor inlet passage and opens out radially into the compressor inlet passage at the compressor impeller. The combustion air stream which is to be supplied via the additional passage is adjustable, with the combustion air stream which is to be supplied being passed via the additional passage in particular in the lower load/speed range of the internal combustion engine, this air stream then striking the compressor impeller blades radially and imparting a driving momentum to them. Due to the pressure gradient across the compressor, combustion air is sucked in from the environment. The compressor which is operated in cold-air turbine mode makes a contribution to maintaining the charger rotational speed. As the load or speed of the internal combustion engine increases, it is possible to reduce the supply of air across the additional passage and ultimately to eliminate this supply of air altogether, so that the combustion air takes the normal path via the compressor inlet passage and strikes the compressor impeller at the end side. At higher loads and speeds of the internal combustion engine, the compressor is operated in compressor mode, with the combustion air which is supplied being compressed to an increased boost pressure.

To eliminate the risk of excessive rotational speeds in the rotor of the exhaust gas turbocharger, the variable turbine geometry, if the exhaust gas turbocharger rotational speed exceeds an upper limit value, can be adjusted in the direction of its open position until the incoming flow exerts a braking action on the turbine wheel, after which the exhaust gas turbine consumes energy and has a braking action on the exhaust gas turbocharger rotational speed. This operating mode is also known as ventilation mode of the exhaust gas turbine. The risk of excessive rotational speeds may occur in particular in the event of load changes in the internal combustion engine from a high load towards a low part-load, which is associated with a considerable pressure drop in the intake section immediately upstream of the cylinder inlets. As a result, the load on the compressor is greatly relieved and it suddenly shifts to cold-air turbine mode, in which the compressor delivers drive energy to the rotor. At the same time, the hot exhaust manifold is responsible for supplying considerable energy to the exhaust gas, with the result that the exhaust gas turbine is also briefly providing further drive energy, which overall would lead to an unacceptably high rise in the exhaust gas turbocharger rotational speed. To avoid this, the variable turbine geometry of the exhaust gas turbocharger is opened as quickly as possible to a sufficient extent for the efficiency of the exhaust gas turbine to become negative and the turbine to be operated in ventilation mode, in which energy is consumed. The resulting, negative power resulting from bearing friction and braking power of the exhaust gas turbine must be greater than the driving power of the compressor which is being operated in cold-air turbine mode.

After the braking influence of the exhaust gas turbine has reduced the exhaust gas turbocharger rotational speed to a permissible level, the variable turbine geometry can return to the position appropriate for the current operating mode, i.e. low loads and speeds of the internal combustion engine can in particular be moved back towards the back-up position.

### BRIEF DESCRIPTION OF THE DRAWINGS

Further advantages and expedient embodiments are given in the further claims, the description of the figures and the drawings, in which:

FIG. 1 diagrammatically depicts an internal combustion engine with exhaust gas turbocharger;

FIG. 2 shows a section through the compressor of the exhaust gas turbocharger, which has an additional passage which runs parallel to the compressor inlet passage and via which combustion air strikes the compressor impeller in the radial direction;

FIG. 3 shows a section through the exhaust gas turbine of the exhaust gas turbocharger, which has a radial and a semiaxial flow inlet cross section, with a variable turbine geometry being arranged in the radial flow inlet cross-section;

FIG. 4 shows a plan view of the variable turbine geometry;

FIG. 5 shows an enlarged side view of a detail of the variable turbine geometry;

FIG. 6 shows a graph of the efficiency curve as a function of the ratio of circumferential velocity to isentropic expansion rate, plotted for the compressor in cold-air turbine mode; and

FIG. 7 shows a graph corresponding to FIG. 6, illustrated for the exhaust gas turbine.

In the figures, identical components are provided with identical reference designations.

### DETAILED DESCRIPTION OF THE PREFERRED EMBODIMENTS

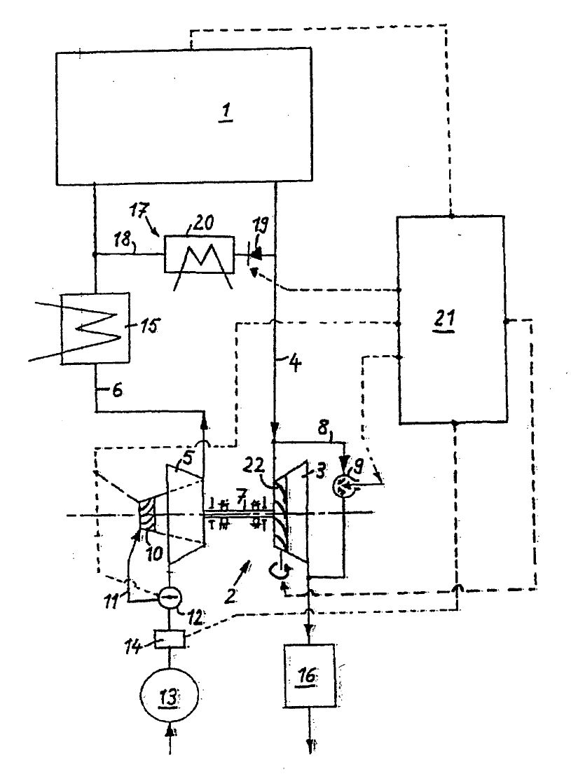

The internal combustion engine 1 illustrated in FIG. 1—a diesel internal combustion engine or a spark ignition engine—is equipped with an exhaust gas turbocharger 2, which comprises an exhaust gas turbine 3 in the exhaust section 4 and a compressor 5 in the intake section 6. The turbine wheel of the exhaust gas turbine 3 is coupled to the compressor impeller in the compressor 5 in a rotationally fixed manner by way of a shaft 7. A bypass 8, which bypasses the exhaust gas turbine 3 by branching off upstream of the exhaust gas turbine and opening back into the exhaust section downstream of the exhaust gas turbine and in which an adjustable blow-off valve 9 is arranged, is provided in the exhaust section 4. The exhaust gas turbine 3 is provided with a variable turbine geometry 22, which can be used to adjust the effective turbine inlet cross section between a minimum back-up position and a maximum open position.

The compressor 5 is equipped with a variable compressor geometry 10, by means of which one of a total of two flow cross sections via which combustion air can be fed to the compressor impeller can be variably adjusted. The cross section of flow with the variable compressor geometry 10 is located in an additional passage 11, which branches off from the compressor inlet passage upstream of the compressor impeller and opens back out into the compressor inlet passage in the radial direction at the compressor impeller. The combustion air stream which is supplied via the additional passage 11 is controlled with the aid of an adjustable blocking valve 12 which can be regulated between a position in which it blocks the additional passage 11 and a position in which it opens the additional passage 11, and moreover can also block or open the axial compressor inlet passage. At medium and high loads or speeds of the internal combustion engine, combustion air is fed onto the compressor impeller in the axial direction via the axial compressor inlet passage, and the compressor impeller is driven by the turbine wheel via the shaft 7 and compresses the combustion air which is supplied to an increased boost pressure. In this operating mode, the additional passage 11 is expediently blocked off. At low loads and speeds of the internal combustion engine, by contrast, the combustion air is supplied via the additional passage 11; in this operating phase, a sub-atmospheric pressure is present immediately upstream of the cylinder inlets, with the result that a pressure gradient is established across the compressor, which can be utilized to drive the charger. The combustion air which is supplied via the additional passage 11 in this operating phase strikes the compressor impeller blades in the radial direction and imparts a driving momentum to them. The flow path across the compressor inlet passage is expediently blocked off in this operating phase.

Upstream of compressor 5, there is an air filter 13 in the intake section, in which air filter the combustion air supplied is purified. An air gauge 14, which is used to measure the air throughput and feed this information as a signal to a control unit 21, is arranged in intake section 6, downstream of air filter 13 and upstream of compressor 5. A charge air cooler 15, in which the combustion air is cooled, is arranged in intake section 6 downstream of compressor 5. Following charge air cooler 15, the combustion air is fed to the cylinders of internal combustion engine 1.

On the exhaust gas side, the exhaust gases which have been expelled from the internal combustion engine are passed via exhaust section 4 to exhaust gas turbine 3, it being possible to influence the efficiency of the exhaust gas turbine by way of the current setting of the variable turbine geometry between back-up position and any desired intermediate positions all the way through to the open position. If appropriate, blow-off via bypass 8 may also be suitable, if blow-off valve 9 is open. Downstream of exhaust gas turbine 3, the exhaust gases are purified in an exhaust gas purification unit 16.

Furthermore, an exhaust gas recirculation device 17, which comprises a recirculation line 18 between exhaust section 4 upstream of exhaust gas turbine 3 and intake section 6 of charge air cooler 15, is provided in the internal combustion engine. In return line 18 there is a controllable recirculation blocking valve 19 and an exhaust gas cooler 20. With the aid of the exhaust gas recirculation, it is possible to produce the NOₓ emissions in particular in the part-load range of the internal combustion engine.

All the adjustable units of the internal combustion engine can be adjusted as a function of state and operating variables by means of a control unit 21. This applies in particular to blocking valve 12, which can be used to control the supply of air into the compressor inlet passage or additional passage 11, the position of variable compressor geometry 10, recirculation blocking valve 19 in recirculation line 18 of exhaust gas recirculation device, and the position of variable turbine geometry 22.

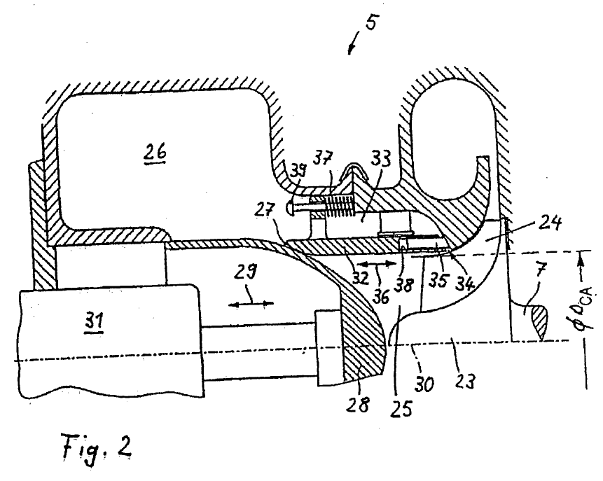

FIG. 2 illustrates compressor 5 in section. A blocking member 28, which can be displaced longitudinally in the direction indicated by arrow 29, is arranged in the axial compressor inlet passage 25, coaxially with respect to longitudinal axis 30, and is displaced in the axial direction by an actuator 31. An air collection space 26 which is offset radially outwards and from which the compressor inlet passage branches off via an entry opening 27, is mounted upstream of axial compressor inlet passage 25. The entry opening 27 is open or, as illustrated in FIG. 2, closed depending on the axial position of blocking-member 28.

An additional passage 33, which likewise branches off from the upstream air collection space 26 and opens back into the compressor inlet passage radially via an opening region 34, with opening region 34 in axial terms located at the level of the compressor impeller blades 24 of compressor impeller 23, is provided parallel to compressor inlet passage 25 but offset radially outwards and separated from the compressor inlet passage by means of an axial slide 32. In the position of blocking member 28 illustrated in FIG. 2, with entry opening 27 to compressor inlet passage 25 blocked, the combustion air which is to be supplied is passed exclusively via additional passage 33 and impinges on compressor impeller blades 24 in the radial direction, imparting a driving momentum to them. A variable compressor geometry, which comprises a swirl grate 35 that is held in a stationary position on a housing wall of the compressor housing and can be slid into a receiving opening 38 located at an end side of adjustable axial slide 32, is arranged in the opening region 34. The opposite end side of axial slide 32 is acted on by blocking member 28 in such a manner that in a position of blocking member 28 close to the compressor impeller, axial slide 32 moves onto swirl grate 35 and swirl grate 35 is pushed into receiving opening 38. In this way, the axial setting position of blocking member 28 can be used not only to adjust entry opening 27 to the compressor inlet passage but also to regulate the free cross section of the opening in region 34 where additional passage 33 opens out. Axial slide 32 executes an axial actuating motion, as indicated by the direction of arrow 36.

Axial slide 32 is acted on by axial forces from a spring element 37 and is pushed away from fixed swirl grate 35. The result of this is that when blocking member 28 moves away from compressor impeller 23, axial slide 32 is also displaced in the same direction as the blocking member by the force of spring element 37, with the result that the free cross section of flow in opening region 34 is increased. The opening movement of axial slide 32 is delimited by a stop 39.

Compressor 5 adopts the position of the blocking member 28 illustrated in FIG. 2 in the low load/speed range of the internal combustion engine, in which a sub-atmospheric pressure is present in the intake section upstream of the compressor. In this state, the combustion air which is to be supplied is passed via additional passage 33 and swirl grate 35 radially onto the compressor impeller blades 34 with swirl grate 35 imparting an additional swirl to the combustion air, and the combustion air strikes the compressor impeller blades with this additional swirl.

As the load and speed increase, blocking member 28 is moved back until entry opening 27 of the compressor inlet passage 25 is opened. Then, combustion air can flow out of air collection space 26 via entry opening 27 into compressor inlet passage 25 and strike the compressor impeller 23 in the axial direction. In this operating mode, the compressor is performing compressor work and compresses the combustion air which is supplied to an increased boost pressure. On the other hand, if there is a pressure drop across the compressor, the combustion air which is supplied via the additional passage 33 delivers a momentum which drives the compressor impeller.

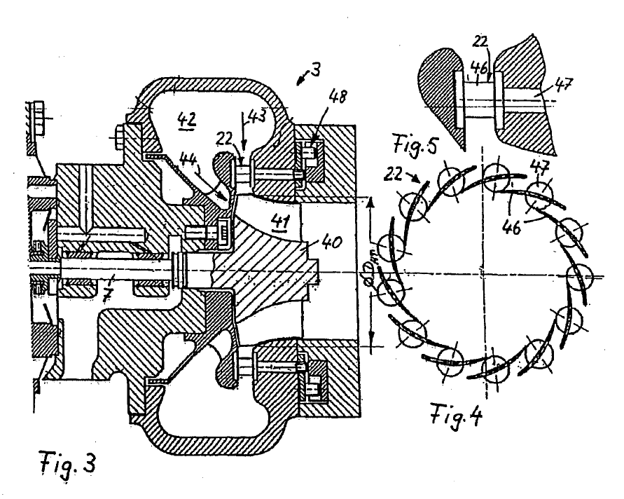

FIG. 3 illustrates the exhaust gas turbine 3 in section. The exhaust gas from the exhaust section is fed to turbine wheel blades 41 of turbine wheel 40 via a spiral passage 42 in the turbine casing. The exhaust gas turbine is designed as a radial/semiaxial turbine and has both a radial turbine inlet cross section, with incoming flow in the direction indicated by arrow 43, and a semiaxial turbine inlet cross section, with flow through it in the direction indicated by arrow 44. In the semiaxial cross section of flow there is a stationary swirl grate, whereas in the radial flow inlet cross section there is variable turbine geometry 22, which can be used to adjust the free flow inlet cross section between a minimum back-up position and a maximum open position.

Variable turbine geometry 22 is illustrated in detail in FIGS. 4 and 5. Variable turbine geometry 22 comprises a plurality of guide vanes 46 which are arranged in a circle and are each mounted rotatably on a guide vane shaft 47, it being possible for guide vane shafts 47 to be actuated by way of an adjustment device 48 (FIG. 3). A flow path is left clear between adjacent guide vanes 46, it being possible to adjust this flow path depending on the position of the guide vanes between the back-up position and the maximum open position.

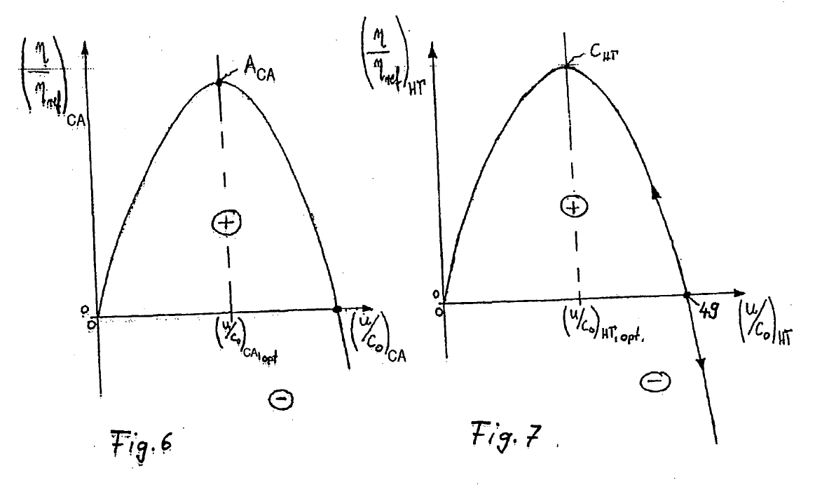

FIGS. 6 and 7 illustrate graphs of the curve of the efficiency as a function of the ratio of the circumferential velocity to the isentropic expansion velocity, specifically in FIG. 6 for the compressor operated in cold-air turbine mode—denoted by “CA” (cold air)—and in FIG. 7 for the exhaust gas turbine—indicated by “HT” for hot turbine. The efficiency η, which is plotted on the Y axis, is standardized to a reference value η_{ref}. c₀ denotes the isentropic expansion rate, which for the compressor operated as a cold-air turbine and for the exhaust gas turbine is determined from the relationship

$${c}_{0} = \sqrt{2 {c}_{p} {T}_{t , in} [ 1 - \frac{1}{{( {p}_{t , in} / {p}_{t , out} )}^{\frac{k \cdot - 1}{k}}} ]}$$

as a function of the heat capacity cₚ of the gas which is in each case flowing through, the temperature T_{t,in} at the compressor impeller or turbine wheel inlet, the compressor or turbine pressure ratio p_{t,in}/p_{t,out} and the isentropic exponent κ. According to this relationship, the isentropic expansion rate cₒ rises as the pressure ratio p_{t,in}/p_{t,out} increases. For the exhaust gas turbine, this means that its isentropic expansion rate cₒ increases if the variable turbine geometry is adjusted in the direction of the back-up position, since with a smaller turbine inlet cross section the exhaust gas back pressure and therefore also the pressure ratio across the exhaust gas turbine increases.

The circumferential velocity u is calculated from
u=D_{CA}πn_{ETC}
u=D_{HT}πn_{ETC}
for the compressor (cold air mode “CA”) or for the exhaust gas turbine (hot turbine “HT”) as a function of the diameter D_{CA} of the compressor impeller or the diameter D_{HT} of the turbine wheel, in each case measured on the blade leading edge, as shown in FIGS. 2 and 3, respectively, and as a function of the number π and the charger rotational speed n_{ETC}.

The ratio u/c₀ of circumferential velocity u and isentropic expansion rate cₒ rises with an increasing charger rotational speed n_{ETC} and drops with an increasing exhaust gas back pressure, on account of the expansion rate c₀ then rising. If the variable turbine geometry is adjusted in the back-up position, the exhaust gas back pressure increases and the ratio u/c₀ decreases.

In both the curves shown in FIGS. 6 and 7, the optimum efficiency is at the top of the approximately bell-shaped efficiency curve. For each curve, the optimum efficiency is approximately at a value of the ratio of the circumferential velocity u to the isentropic expansion rate c₀ of 0.7. The respective optimum efficiency at this value is marked by points A_{CA} and C_{HT}. To enable this value to be reached in both curves, it is necessary, in operating phases of the internal combustion engine in which there is a sub-atmospheric pressure in the intake section and the compressor is being run in cold-air turbine mode, for the variable turbine geometry of the exhaust gas turbine to be adjusted in the direction of its back-up position until the turbine efficiency of the exhaust gas turbine illustrated in FIG. 7 is at least approximately in the region of the optimum efficiency, which is reached at a u/c₀ ratio of approximately 0.7. Without the correction by way of the adjustment of the variable turbine geometry, the ratio of circumferential velocity to isentropic expansion rate for the turbine would be at a considerably higher value, possibly even above the point where the efficiency curve intersects the X axis, which marks the switch from driving mode to ventilation mode, where the exhaust gas turbine starts to consume energy; the reason for this is the low pressure drop at low loads and speeds of the internal combustion engine, which according to the relationship given above for the calculation of the isentropic expansion rate c₀ leads to a relatively low value of the expansion rate and therefore to a high ratio of circumferential velocity to expansion rate. With the aid of the adjustment of the variable turbine geometry in the direction of the back-up position, the exhaust gas back pressure is increased, as is the isentropic expansion rate c₀, and as a result the ratio of circumferential velocity to expansion rate is reduced towards the optimum efficiency. This adjustment ensures that the exhaust gas turbine outputs driving power to the charger shaft even at low loads and speeds, and therefore makes a contribution to maintaining the rotational speed level of the charger.

To prevent unacceptably high rotational speeds of the rotor of the exhaust gas turbocharger, which can occur in particular in the event of load changes from a high load on the internal combustion engine toward a low part-load, since in this case a sub-atmospheric pressure is established on the compressor side downstream of the compressor, which additionally drives the compressor but at the same time supplies reheating energy from the exhaust manifold on the exhaust gas side for heating and a correspondingly high energy in the exhaust gas, with the result that drive energy is likewise additionally acting on the charger shaft, in this case the variable turbine geometry is adjusted in the direction of its open position until the efficiency curve shown in FIG. 7 passes into its negative range and the exhaust gas turbine, in ventilation mode, is consuming energy and as a result braking the charger shaft. This widening of the cross section is generally achieved by adjusting the variable turbine geometry in the direction of its open position; if appropriate, however, it is also possible for the blow-off valve in the bypass to the exhaust gas turbine to be opened. Braking is achieved if the sum of the power loss which is composed of contributions from the bearing friction and the braking power of the exhaust gas turbine, is greater than the driving power on the side of the compressor, which is being operated in cold-air turbine mode and is driving the rotor.

After the exhaust gas turbocharger rotational speed has reached a desired rotational speed level, in particular has dropped back to a lower rotational speed level, the variable turbine geometry can be adjusted back in the direction of its back-up position, in order to move the exhaust gas turbine out of the ventilation mode, in which it consumes energy, into the driving mode, in which it outputs energy. This adjustment of the variable turbine geometry in the direction of its back-up position can be carried out as soon as a parameter assigned to the exhaust gas turbocharger rotational speed adopts a defined value, for example if the exhaust gas turbocharger rotational speed is below a defined limit value for a minimum period of time.

Accordingly, while only a few embodiments have been have been shown and described, it is obvious that many changes and modifications may be made thereunto without departing from the spirit and scope of the invention.

What is claimed is:

1. A method for operating a supercharged internal combustion engine having an exhaust gas turbocharger with a compressor in an intake section and an exhaust gas turbine in an exhaust section, comprising the following steps:
providing the exhaust gas turbine with a variable turbine geometry for variably adjusting an effective turbine inlet cross section between a minimum back-up position and a maximum open position,
running the compressor in turbine mode, and
adjusting the variable turbine geometry in a direction of the back-up position until a turbine efficiency of the exhaust gas turbine is at least above a ventilation point and is moving into a range of optimum efficiency when the internal combustion engine is in a lower load/speed range, in which pressure upstream of the compressor is higher than the pressure downstream of the compressor.

2. A method according to claim 1, wherein the compressor has an additional passage, said passage opening out radially at a compressor impeller into a compressor inlet passage, and further comprising the step of introducing an adjustable combustion air stream into the additional passage and passing the air stream through said passage when the internal combustion engine is in the lower load/speed range.

3. A method according to claim 1, wherein when a rotation speed of the exhaust gas turbocharger reaches a limit value, the variable turbine geometry is adjusted in the direction of the open position until the turbine efficiency of the exhaust gas turbine reaches a negative value below the ventilation point and the exhaust gas turbine is consuming energy.

4. A method according to claim 3, wherein the variable turbine geometry is further adjusted in the direction of the back-up position until the exhaust gas turbocharger rotational speed adopts a desired rotational speed level.

5. A method according to claim 1, wherein the variable turbine geometry is configured as a blow-off turbine, and further comprising the step of effecting an adaptation of a turbine pressure gradient based on a desired efficiency characteristic across a blow-off member of the blow-off turbine.
